(19) United States
(12) Patent Application Publication
(10) Pub. No.: US 2007/0279561 A1
(43) Pub. Date: Dec. 6, 2007

(54) Systems for displaying images

(75) Inventor: Chi-Huang Lin, Yongkang City (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 11/810,165

(22) Filed: Jun. 5, 2007

(30) Foreign Application Priority Data
Jun. 6, 2006 (TW) 095120000

(51) Int. Cl. G02F 1/1335

(52) U.S. Cl. 349/119

(57) ABSTRACT

Systems for displaying images are provided. A representative system comprises a liquid crystal display (LCD) panel. A liquid crystal display panel includes a first substrate, a second substrate, and a liquid crystal layer therebetween. A first biaxial 1/4λ compensation film is interposed between a first polarizer and the first substrate. A second biaxial 1/4λ compensation film is interposed between a second polarizer and the second substrate. The first and second biaxial 1/4λ compensation films comply with N_{z1}+N_{z2}=1, where N_{z}=(nₓ−n_{z})/(nₓ−n_{y}), nₓ, n_{y}, n_{z} each represent refraction index of x, y, z axes of the compensation films, and N_{z1} and N_{z2} each represent biaxial factor of the first and second biaxial 1/4λ compensation films.

### BACKGROUND OF THE INVENTION

1. Field of the Invention

The invention relates to systems for displaying images, and more particularly to multiple film compensated high brightness vertical alignment liquid crystal display (VA-LCD) devices.

2. Description of the Related Art

Liquid crystal displays (LCDs) are widely used in information displays. Due to the intrinsic optical anisotropy of liquid crystal display materials, incident light transmitted from different directions can produce different effective birefringence. Therefore, the viewing angle of conventional LCDs is not as wide as in self-emitting displays, such as cathode-ray tubes (CRTs), organic light-emitting diodes (OLEDs) and plasma display panels (PDPs).

To widen the viewing angle, several display modes using lateral electric fields to activate LC molecules, such as multi-domain vertical alignment (MVA) mode have been adopted. By creating bumps and protrusions on the substrate, multiple domains with different liquid crystal orientations are formed. As electric field distribution in the LC cell is changed, alignment and relaxation of liquid crystal molecules is changed correspondingly.

FIG. 1 is a schematic view of a conventional vertical alignment liquid crystal display (VA-LCD) device comprising a VA-LC cell interposed between upper polarizer 30 and lower polarizer 10, both liner polarizers with perpendicular optical axes. Conventional VA-LCD devices, however, exhibit narrow viewing angles in diagonal directions. More specifically, at viewing angles of 45°, 135°, 225°, and 315°, appropriate compensation is required to improve display quality.

FIG. 2 is a schematic view of a conventional vertical alignment liquid crystal display (VA-LCD) device compensated by two 1/4λ compensation films. To achieve wide viewing angles two 1/4λ compensation films 25 and 15 are respectively disposed between the upper polarizer 30 and the LC cell 20 and between the lower polarizer 10 and the LC cell 20. The combination of the 1/4λ compensation film 25 and the upper polarizer 30 serves as a circular polarizer. Conversely, the combination of the 1/4λ compensation film 15 and the lower polarizer 10 can serve as another circular polarizer. A negative C-axis compensation film (not shown) is proposed to compensate the LC cell such that incident light travels the same birefringence rendering wide and symmetrical images. The total retardation change is a product of birefringence Δn, of the liquid crystal molecules and total path length traveled by the incident light in the liquid crystal layer. The efficiency of incident light passing through the LCD device, however, depends on total retardation change.

### BRIEF SUMMARY OF THE INVENTION

Accordingly, the invention provides a VA-LCD device compensated by two 1/2λ compensation films.

The invention provides a system for displaying images, comprising a liquid crystal display (LCD) panel comprising a first substrate, a second substrate, and a liquid crystal layer therebetween. A first biaxial 1/4λ compensation film is disposed on the outer surface of the first substrate. A second biaxial 1/4λ compensation film is disposed on the outer surface of the second substrate. The first and second biaxial 1/4λ compensation films comply with N_{z1}+N_{z2}=1, where N_{z}=(nₓ−n_{z})/(nₓ−n_{y}), nₓ, n_{y}, n_{z} each represent refraction index of x, y, z axes of the compensation films, and N_{z1} and N_{z2} each represent biaxial factors of the first and second biaxial 1/4λ compensation films.

The invention also provides a system for displaying images, comprising a liquid crystal display (LCD) panel comprising a first substrate, a second substrate, and a liquid crystal layer therebetween. A first biaxial 1/4λ compensation film is disposed on the outer surface of the first substrate. A second biaxial 1/4λ compensation film is disposed on the outer surface of the second substrate. A first polarizer is disposed outside the first substrate opposing the liquid crystal layer. A second polarizer is disposed outside the second substrate opposing the liquid crystal layer. The first and second biaxial 1/4λ compensation films comply with N_{z1}+N_{z2}=1, where N_{z}=(nₓ−n_{z})/(nₓ−n_{y}), nₓ, n_{y}, n_{z} each represent refraction index of x, y, z axes of the compensation films, and N_{z1} and N_{z2} each represent biaxial factor of the first and second biaxial 1/4λ compensation films.

### BRIEF DESCRIPTION OF THE DRAWINGS

The invention can be more fully understood by reading the subsequent detailed description and examples with references made to the accompanying drawings, wherein:

FIG. 1 is a schematic view of a conventional vertical alignment liquid crystal display (VA-LCD) device;

FIG. 2 is a schematic view of a conventional vertical alignment liquid crystal display (VA-LCD) device compensated by two 1/4λ compensation films;

FIG. 3 is an exploded view of an embodiment of a multi-film compensated vertical alignment liquid crystal display device;

FIG. 4 shows the relationship of the slow axis of the biaxial 1/4λ optical compensation film dependent from the biaxial factor N_{z} at different viewing angles;

FIG. 5 is an exploded view of another embodiment of a multi-film compensated vertical alignment liquid crystal display device;

FIG. 6 is a schematic diagram of a display device comprising the multi-film compensated vertical alignment liquid crystal display panel of the invention; and

FIG. 7 is a schematic diagram of an electronic device, incorporating a display device comprising the vertical alignment liquid crystal display panel of the invention.

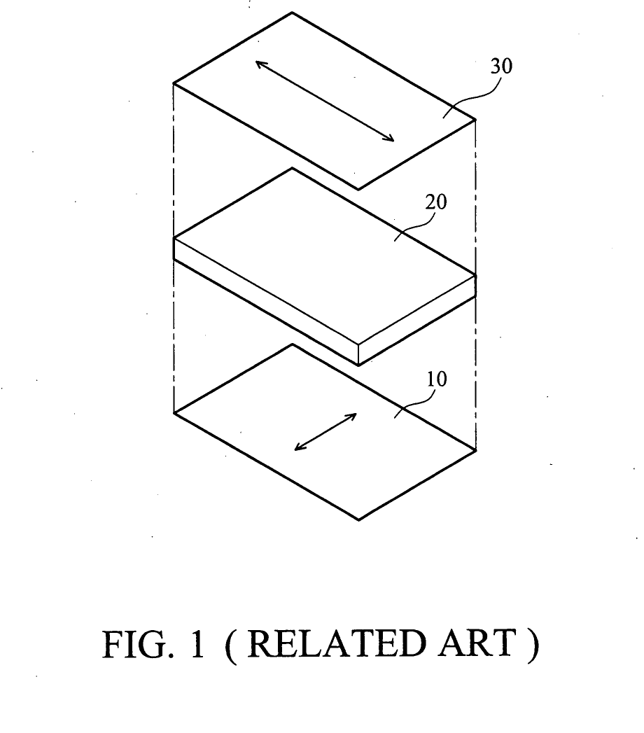

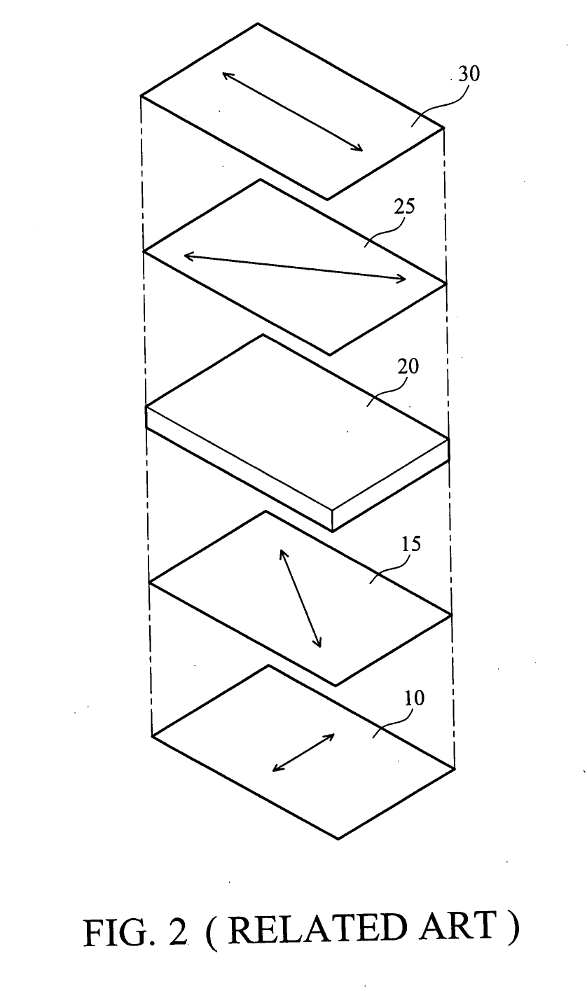

### DETAILED DESCRIPTION OF THE INVENTION

Embodiments of the invention provide a system for displaying images. A VA-LCD device compensated by two 1/2λ compensation films provides ameliorated light leakage at high inclined angles, yielding a wider viewing angle. The system for displaying images can comprise an LCD panel cooperating with two 1/2λ compensation films, and alternatively further cooperating with a C-axis optical compensation film, an A-axis optical compensation film, or a biaxial optical compensation film.

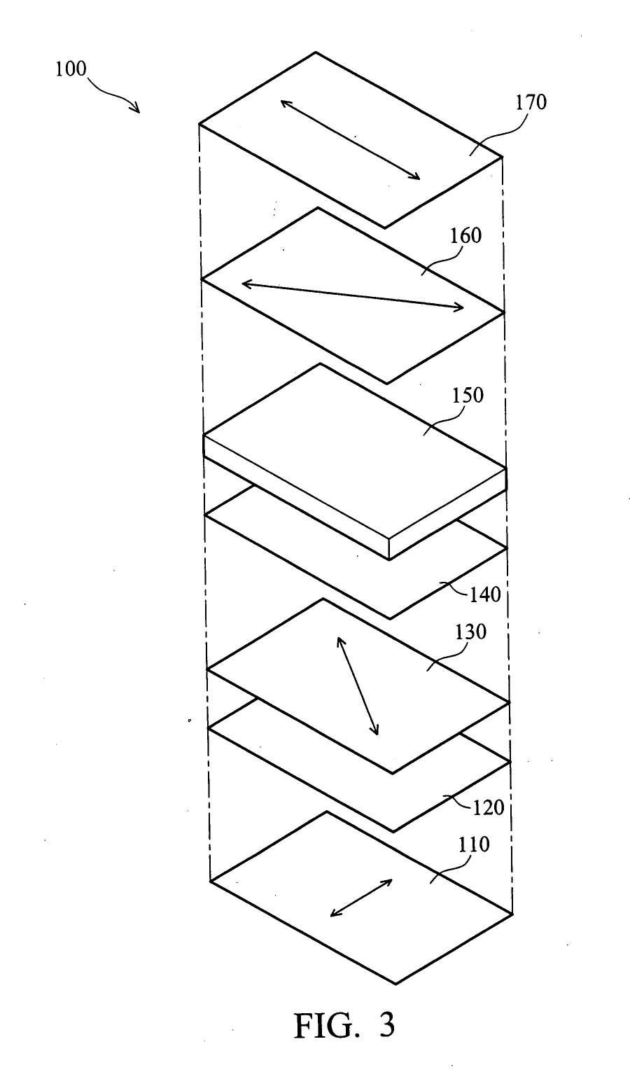

FIG. 3 is an exploded view of an embodiment of a multi-film compensated vertical alignment liquid crystal display device. A liquid crystal display panel 100 comprises a liquid crystal display cell 150 with a first substrate, a second substrate, and a liquid crystal layer therebetween. A first polarizer 110 is disposed outside the liquid crystal display cell 150. A second polarizer 170 is disposed outside the liquid crystal display cell 150. The first and second polarizers 110 and 170 are both circular polarizers. A first biaxial 1/4λ compensation film 130 is interposed between the first polarizer 110 and the liquid crystal display cell 150. A second biaxial 1/4λ compensation film 160 is interposed between the second polarizer 170 and the liquid crystal display cell 150.

A C-axis optical compensation film 140 is optionally interposed between the first biaxial 1/4λ compensation film 130 and the liquid crystal display cell 150 to compensate light leakage of the liquid crystal display cell 150. The C-axis optical compensation film 140 can alternatively be interposed between the second biaxial 1/4λ compensation film 160 and the liquid crystal display cell 150 to compensate light leakage of the second biaxial 1/4λ compensation film 160. A biaxial 1/2λ compensation film 120 is interposed between the first polarizer 110 and the first biaxial 1/4λ compensation film 130 to compensate light leakage of the first polarizer 110. The biaxial 1/2λ compensation film 120 can alternatively be interposed between the second polarizer 170 and the second biaxial 1/4λ compensation film 160 to compensate light leakage of the second polarizer 170.

The first and second biaxial 1/4λ optical compensation films 130 and 160 comply with N_{z1}+N_{z2}=1, where N_{z}=(nₓ−n_{z})/(nₓ−n_{y}), nₓ, n_{y}, n_{z} each represent refraction index of x, y, z axes of the biaxial 1/4λ optical compensation films, and N_{z1} and N_{z2} each represent biaxial factor of the first and second biaxial 1/4λ compensation films 130 and 160. Furthermore, the slow axis of the first biaxial 1/4λ compensation film 130 and the slow axis of the second 1/4λ compensation film 160 are perpendicular to each other. Here, the circular polarizer maintains high brightness in a normal direction, while maintaining high viewing angles at inclined direction.

The biaxial factors N_{z1} and N_{z2} of the first and second biaxial 1/4λ optical compensation films 130 and 160 are respectively represented by numerals 0 and 1, 0.25 and 0.75, or 0.5 and 0.5. Each of the biaxial factors N_{z1} and N_{z2} can effectively ameliorate viewing angle problems at high inclined angles.

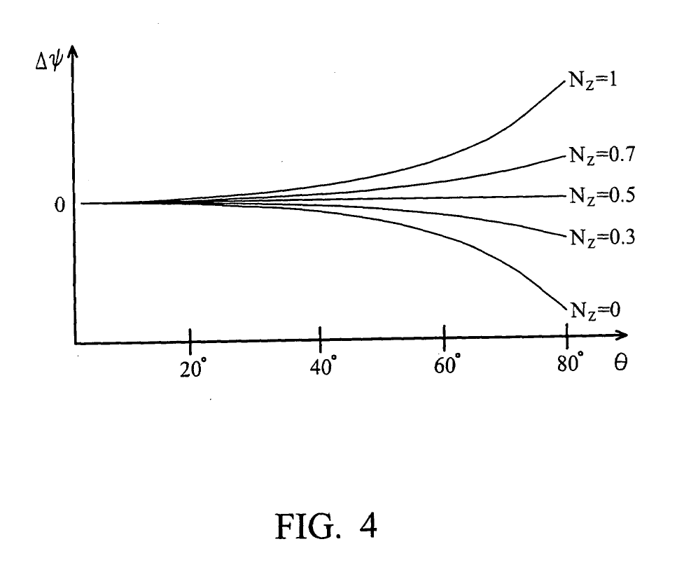

FIG. 4 shows the relationship of the slow axis of the biaxial 1/4λ optical compensation film dependent from the biaxial factor N_{z} at different viewing angles. Referring to FIG. 4, where N_{z}>0.5 and N_{z}<0.5, the slow axes of the of the biaxial 1/4λ optical compensation film dependent from viewing angles θ are symmetric to a symmetrical center where N_{z}=0.5. When the two biaxial 1/4λ optical compensation films comply with N_{z1}+N_{z2}=1, the slow axes of the two biaxial 1/4λ optical compensation films do not change with viewing angle θ. Accordingly, when N_{z1}+N_{z2}=1, the slow axis of the first biaxial 1/4λ compensation film and a slow axis of the second biaxial 1/4λ compensation film are perpendicular to each other in both normal and inclined directions.

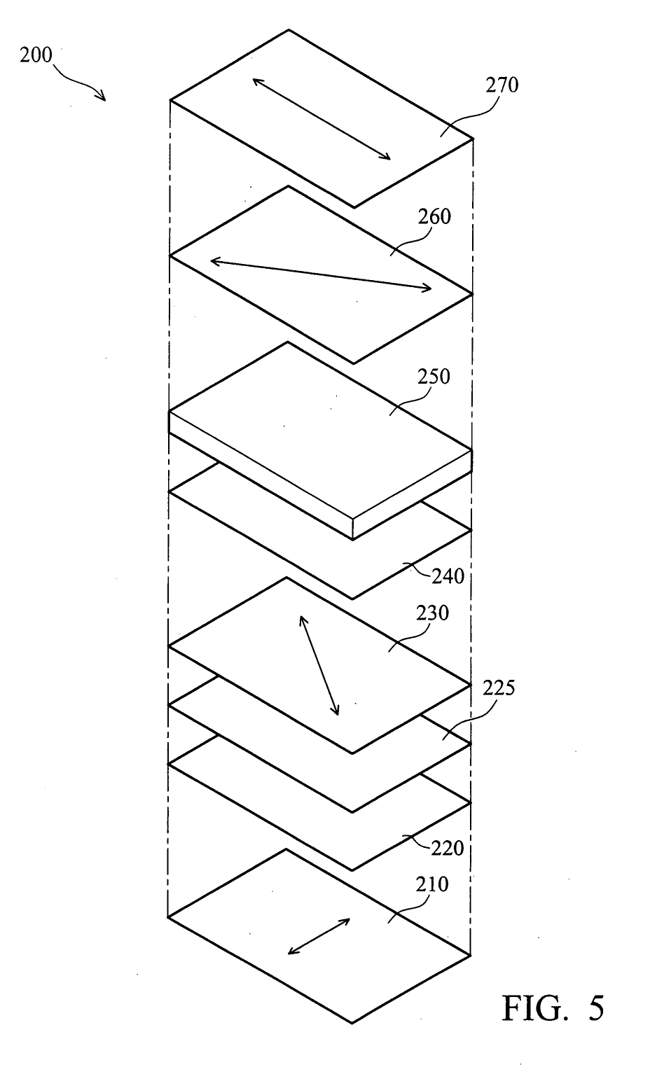

FIG. 5 is an exploded view of another embodiment of a multi-film compensated vertical alignment liquid crystal display device. A liquid crystal display panel 200 comprises a liquid crystal display cell 250 with a first substrate, a second substrate, and a liquid crystal layer therebetween. A first polarizer 210 is disposed outside the liquid crystal display cell 250. A second polarizer 270 is disposed outside the liquid crystal display cell 250. The first and second polarizers 210 and 270 are both circular. A first biaxial 1/4λ compensation film 230 is interposed between the first polarizer 210 and the liquid crystal display cell 250. A second biaxial 1/4λ compensation film 260 is interposed between the second polarizer 270 and the liquid crystal display cell 250.

A C-axis optical compensation film 240 is optionally interposed between the first biaxial 1/4λ compensation film 230 and the liquid crystal display cell 250 to compensate light leakage of the liquid crystal display cell 250. A C-axis optical compensation film 225 and an A-axis optical compensation film 250 are interposed between the first polarizer 210 and the first biaxial 1/4λ compensation film 230 to compensate light leakage of the first polarizer 210. The C-axis optical compensation film 225 and the A-axis optical compensation film 250 can alternatively be interposed between the second polarizer 270 and the second biaxial 1/4λ compensation film 260 to compensate light leakage of the second polarizer 270.

The first and second biaxial 1/4λ optical compensation films 230 and 260 comply with N_{z1}+N_{z2}=1, where N_{z}=(nₓ−n_{z})/(nₓ−n_{y}), nₓ, n_{y}, n_{z} each represent refraction index of x, y, z axes of the biaxial 1/4λ optical compensation films 230 and 260, and N_{z1} and N_{z2} each represent biaxial factor of the first and second biaxial 1/4λ compensation films 230 and 260. Furthermore, the slow axis of the first biaxial 1/4λ compensation film 230 and the slow axis of the second 1/4λ compensation film 260 are perpendicular to each other. Under this circumstance, the circular polarizer maintains high brightness at normal direction, while maintaining high viewing angles at inclined direction.

The biaxial factors N_{z1} and N_{z2} of the first and second biaxial 1/4λ optical compensation films 230 and 260 can respectively be represented by numerals 0 and 1, 0.25 and 0.75, or 0.5 and 0.5. Each of the biaxial factors N_{z1} and N_{z2} can effectively ameliorate viewing angle problems at high inclined angles.

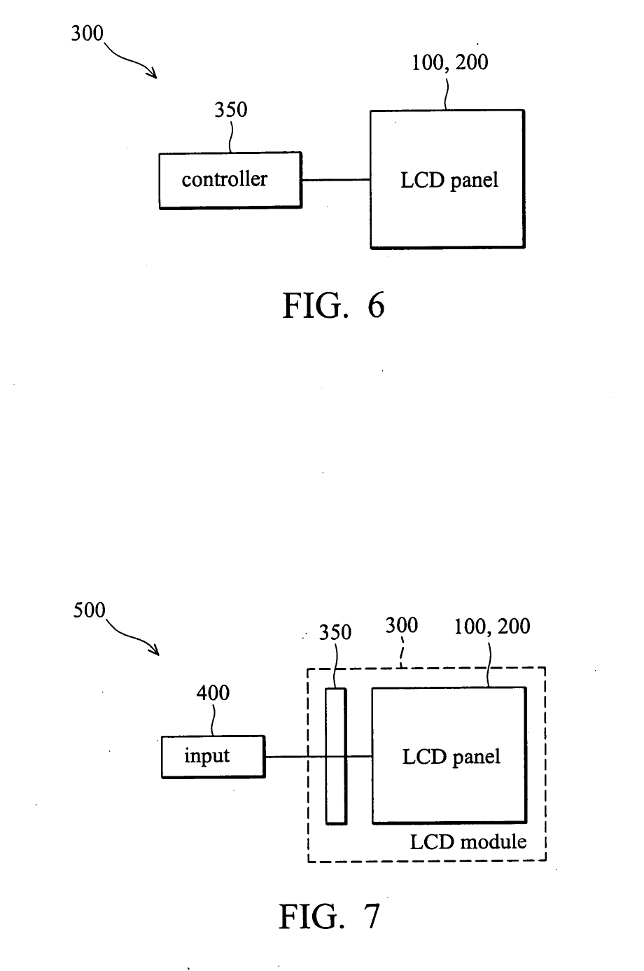

FIG. 6 is a schematic diagram of a display device 300 comprising the multi-film compensated liquid crystal display panel of the invention. The multi-film compensated vertical alignment liquid crystal display panel 100 or 200 can be coupled to a controller 350, forming a display device 300 as shown in FIG. 6. The controller 335 can comprise a source and a gate driving circuit (not shown) to control the vertical alignment liquid crystal display panel 100 or 200 to render image in accordance with an input.

FIG. 7 is a schematic diagram of an electronic device 500, incorporating a display device comprising the vertical alignment liquid crystal display panel of the invention. An input device 400 is coupled to the controller 350 of the display device 300 shown in FIG. 7 can include a processor or the like to input data to the controller 350 to render an image. The electronic device 500 may be a portable device such as a PDA, notebook computer, tablet computer, cellular phone, or a desktop computer.

The invention provides a VA-LCD device compensated by two 1/2λ compensation films. The first and second biaxial 1/4λ optical compensation films 230 and 260 comply with N_{z1}+N_{z2}=1 and the slow axis of the first biaxial 1/4λ compensation film 230 and the slow axis of the second 1/4λ compensation film 260 are perpendicular to each other, thereby ameliorating light leakage at high inclined angles and yielding a wider viewing angle of the VA-LCD device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images comprising:
a liquid crystal display (LCD) panel comprising:
a first substrate, a second substrate, and a liquid crystal layer therebetween;
a first biaxial 1/4λ compensation film disposed on the outer surface of the first substrate; and
a second biaxial 1/4λ compensation film disposed on the outer surface of the second substrate;
wherein the first and second biaxial 1/4λ compensation films comply with N_{z1}+N_{z2}=1, where N_{z}=(nₓ−n_{z})/(nₓ−n_{y}), nₓ, n_{y}, n_{z} each represent refraction index of x, y, z axes of the compensation films, and N_{z1} and N_{z2} each represent biaxial factor of the first and second biaxial 1/4λ compensation films.

2. The system for displaying images as claimed in claim 1, wherein the LCD panel comprises a vertical alignment LCD panel.

3. The system for displaying images as claimed in claim 1, wherein a slow axis of the first biaxial 1/4λ compensation film and a slow axis of the second biaxial 1/4λ compensation film are perpendicular to each other.

4. The system for displaying images as claimed in claim 1, further comprising:
a first polarizer disposed outside the first substrate opposing the liquid crystal layer; and
a second polarizer disposed outside the second substrate opposing the liquid crystal layer.

5. The system for displaying images as claimed in claim 4, further comprising a biaxial 1/2λ compensation film interposed between the first polarizer and the first 1/4λ compensation film.

6. The system for displaying images as claimed in claim 4, further comprising:
a C-axis compensation film and an A-axis compensation film interposed between the first polarizer and the biaxial 1/4λ compensation film,
wherein the A-axis compensation film is directly disposed with the first polarizer.

7. The system for displaying images as claimed in claim 4, wherein the first polarizer and the second polarizer comprise a circular polarizer.

8. The system for displaying images as claimed in claim 1, further comprising a controller coupled to the liquid crystal display panel to control the panel to render an image in accordance with an input.

9. The system for displaying images as claimed in claim 8, further comprising an input device coupled to the controller of the liquid crystal display device to control the display device to render an image.

10. A system for displaying images comprising:
a liquid crystal display (LCD) panel comprising:
a first substrate, a second substrate, and a liquid crystal layer therebetween;
a first biaxial 1/4λ compensation film disposed on the outer surface of the first substrate;
a second biaxial 1/4λ compensation film disposed on the outer surface of the second substrate;
a first polarizer disposed outside the first substrate opposing the liquid crystal layer; and
a second polarizer disposed outside the second substrate opposing the liquid crystal layer;
wherein the first and second biaxial 1/4λ compensation films comply with N_{z1}+N_{z2}=1, where N_{z}=(nₓ−n_{z})/(nₓ−n_{y}), nₓ, n_{y}, n_{z} each represent refraction index of x, y, z axes of the compensation films, and N_{z1} and N_{z2} each represent biaxial factor of the first and second biaxial 1/4λ compensation films.

11. The system for displaying images as claimed in claim 10, wherein the LCD panel comprises a vertical alignment LCD panel.

12. The system for displaying images as claimed in claim 10, wherein a slow axis of the first biaxial 1/4λ compensation film and a slow axis of the second biaxial 1/4λ compensation film are perpendicular to each other.

13. The system for displaying images as claimed in claim 10, further comprising a biaxial 1/2λ compensation film interposed between the first polarizer and the first 1/4λ compensation film.

14. The system for displaying images as claimed in claim 10, wherein the first polarizer and the second polarizer comprise a circular polarizer.

15. The system for displaying images as claimed in claim 10, further comprising:
a C-axis compensation film and an A-axis compensation film interposed between the first polarizer and the biaxial 1/4λ compensation film,
wherein the A-axis compensation film is directly disposed with the first polarizer.

16. The system for displaying images as claimed in claim 10, further comprising a controller coupled to the liquid crystal display panel to control the panel to render an image in accordance with an input.

17. The system for displaying images as claimed in claim 6, further comprising an input device coupled to the controller of the liquid crystal display device to control the display device to render an image.
